(19) United States
(12) Patent Application Publication
(10) Pub. No.: US 2019/0321700 A1
(43) Pub. Date: Oct. 24, 2019

(54) CARBON FIBER CASING OF GOALKEEPER PU FOAM HOCKEY STICK AND PRODUCTION PROCESS THEREOF

(71) Applicants: Joseph Hsu, Zhongshan City (CN); ZHONGSHAN FUDA SPORTS APP CO., LTD., Zhongshan City (CN)

(72) Inventor: Joseph HSU, Taichung City (TW)

(21) Appl. No.: 16/386,668

(22) Filed: Apr. 17, 2019

(30) Foreign Application Priority Data
Apr. 18, 2018 (CN) 201810348780.7

(51) Int. Cl. A63B 59/70; B32B 1/00; B32B 5/18; B32B 5/24; B32B 27/12; B32B 27/40; B29C 44/12; B29C 70/34

(52) U.S. Cl. CPC A63B 59/70; B32B 1/00; B32B 5/18; B32B 5/245; B32B 27/12; B32B 27/40; B29K 2075/00; B29C 70/342; B32B 2266/0278; B32B 2262/106; B32B 2260/021; B32B 2260/046; B29C 44/128

(57) ABSTRACT

A carbon fiber casing of a goalkeeper PU foam hockey stick and a production process thereof are disclosed. The carbon fiber casing of the goalkeeper PU foam hockey stick comprises a reinforcing carbon fiber casing, a wood or fiber stick and PU foam. A reinforcing part is arranged on the PU foam. The reinforcing carbon fiber casing is forcibly disposed around the corresponding reinforcing part of the PU foam. The PU foam is laminated onto the wood or fiber stick together with the reinforcing carbon fiber casing. The reinforcing carbon fiber casing is formed by heating fibers and epoxy resin in a mold, so that the strength of the whole goalkeeper PU foam hockey stick is improved.

### BACKGROUND OF THE INVENTION

### 1. Technical Field

The invention relates to the technical field of sports equipment, in particular to a carbon fiber casing of a goalkeeper PU foam hockey stick and a production process thereof.

### 2. Description of Related Art

At present, goalkeeper PU foam hockey sticks have remarkable advantages when used by hockey goalkeepers. For instance, these goalkeeper PU foam hockey sticks have a good shock-absorption property, so that the hands of players are protected against vibration in matches, and a hockey ball can be well caught without obvious rebound, and the drop point of the hockey ball can be better controlled by the goalkeepers. However, the bottom of the goalkeeper PU foam hockey sticks can be easily cracked due to its frequent hitting against the ground, thereby being nondurable, vulnerable and short in service life.

The production process of the existing goalkeeper PU foam hockey sticks is as follows: a certain quantity of foam is injected into a wood or fiber stick through a mold so as to form a desired shape, and after the stick stands for a certain period of time, and fiber woven fabric or a carbon sheet (synthesized by carbon fibers) is laminated onto the stick to form the goalkeeper PU foam hockey stick. Due to the lack of protection of the bottom foam on the lower edge by a protective layer, the bottom of the hockey sticks may crack once severely impacted when the hockey sticks are used by players for training and matches, and consequentially, the service life is shortened.

### BRIEF SUMMARY OF THE INVENTION

The objective of the invention is to provide a durable impact-resistant bottom carbon fiber casing of a goalkeeper PU foam hockey stick and a production process thereof to solve the problem, mentioned in the description of related art, that the bottom of existing goalkeeper PU foam hockey sticks is not resistant to impact.

According to one technical solution adopted by the invention to fulfill the above objective, a bottom carbon fiber casing of a goalkeeper PU foam hockey stick comprises a reinforcing carbon fiber casing, a wood or fiber stick and PU foam. A reinforcing part is arranged on the PU foam. The reinforcing carbon fiber casing is forcibly disposed around the corresponding reinforcing part of the PU foam. The PU foam is laminated onto the wood or fiber stick together with the reinforcing carbon fiber casing.

Preferably, a surface of the reinforcing part of the PU foam is coated with resin glue.

Preferably, the PU foam, together with the reinforcing carbon fiber casing, is laminated onto the wood or fiber stick by means of a special carbon sheet or woven fabric through a machine.

According to another technical solution, a production process of the bottom carbon fiber casing of the goalkeeper PU foam hockey stick comprises the following steps:

S1, manufacturing a metal fixture and a mold according to the shape of the bottom reinforcing part, wherein the metal fixture and the mold are matched with the reinforcing part in shape and size;

S2, laminating epoxy resin and fibers to form a piece of fabric having an FAW of 150#, and then cutting the fabric to a size required in a structure sheet;

S3, attaching a fiber resin material (the fabric) to the fixture after cutting, and vacuumizing the fiber resin material by a vacuum machine;

S4, placing the fixture attached with the fiber resin material in the heated mold for formation, and conducting deburring and surface treatment on a carbon fiber casing discharged out of the mold, so that the bottom reinforcing carbon fiber casing is formed;

S5, injecting a certain quantity of PU foam into the wood or fiber stick through a mold to form a desired shape, and removing redundant burrs;

S6, roughening a bottom, where the reinforcing carbon fiber casing is to be assembled, of the PU foam, coating the bottom of the PU foam with resin glue, and forcibly disposing the reinforcing carbon fiber casing manufactured in S4 around the bottom of the PU foam, so that reinforcing is completed; and

S7, laminating the reinforced PU foam onto the wood or fiber stick by means of fiber woven fabric or a carbon sheet after the reinforced PU foam stands for about 7 days, so that the goalkeeper PU foam hockey stick is obtained.

Preferably, in S4, the mold is heated to a temperature of 140° C., and a formation time is 600 s.

Preferably, an inner wall of the reinforcing carbon fiber casing is roughened and sand-blasted.

Compared with the prior art, the invention has the following beneficial effects:

According to the bottom carbon fiber casing of the goalkeeper PU foam hockey stick and the production process thereof, the reinforcing carbon fiber casing is formed by heating fibers and epoxy resin in a mold, so that the strength of the whole goalkeeper PU foam hockey stick is improved; and compared with hockey sticks produced through traditional production processes, the goalkeeper PU foam hockey stick of the invention is resistant to impact and has the bottom being protected against cracks, and the service life of the goalkeeper PU foam hockey stick is effectively prolonged.

### BRIEF DESCRIPTION OF THE SEVERAL VIEWS OF THE DRAWINGS

FIG. 1 is an overall disassembled view of the invention;

FIG. 2 is an overall structural view of the first embodiment of the invention;

FIG. 3 is a process flow diagram of the invention; and

FIG. 4 is an overall structural view of the third embodiment of the invention.

### DETAILED DESCRIPTION OF THE INVENTION

The technical solutions in embodiments of the invention are clearly and completely described below with reference to the drawings accompanying the embodiments. Apparently, the embodiments in the following description are only illustrative ones and are not all possible ones of the invention. All other embodiments obtained by those ordinarily skilled in this field based on these illustrative ones without creative work should also fall within the protection scope of the invention.

### Embodiment 1

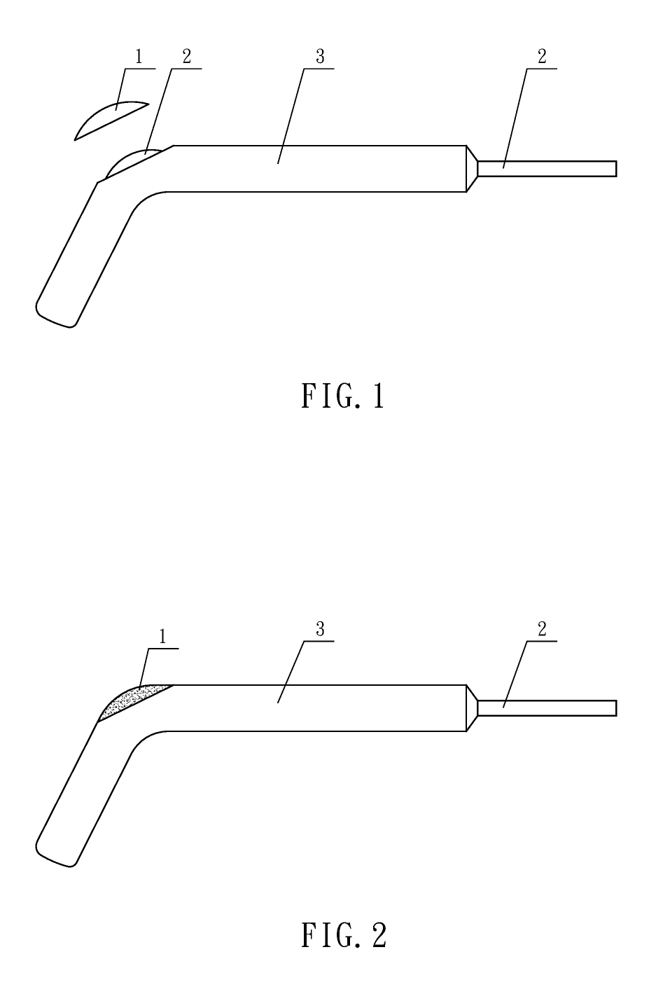

Referring to FIGS. 1-2, a bottom carbon fiber casing of a goalkeeper PU foam hockey stick comprises a reinforcing carbon fiber casing 1, a wood or fiber stick 2 and PU foam 3. A reinforcing part is arranged on the PU foam 3, and a surface of the reinforcing part is coated with resin glue. The reinforcing carbon fiber casing 1 is forcibly disposed around the corresponding reinforcing part of the PU foam 3. The PU foam 3 is laminated onto the wood or fiber stick 2 together with the reinforcing carbon fiber casing 1, wherein the PU foam 3, together with the reinforcing carbon fiber casing 1, is laminated onto the wood or fiber stick 2 by means of a special carbon sheet or woven fabric through a machine.

### Embodiment 2

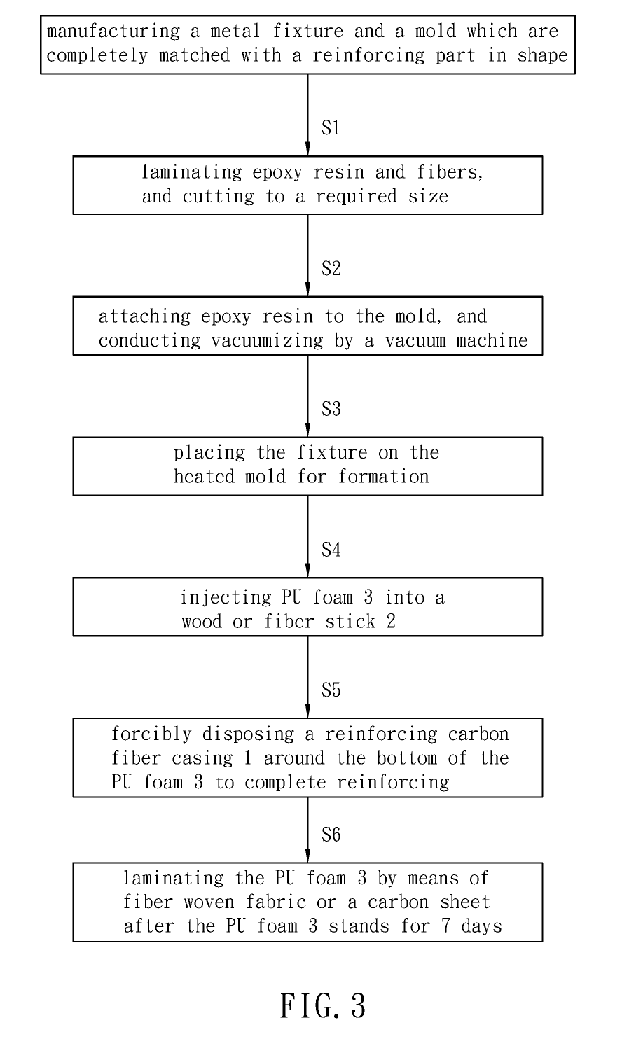

Referring to FIG. 3, based on the above description of embodiment 1, a production process of the bottom carbon fiber casing of the goalkeeper PU foam hockey stick comprises the following steps:

S1, a metal fixture and a mold are manufactured according to the shape of the bottom reinforcing part, wherein the metal fixture and the mold are completely matched with the reinforcing part in shape and size;

S2, epoxy resin and fibers are laminated to form a piece of fabric having an FAW of 150#, and then the fabric is cut to a size required in a structure sheet;

S3, after being cut, a fiber resin material (the fabric) is attached to the fixture and is vacuumized by a vacuum machine;

S4, the fixture attached with the fiber resin material is placed in the mold heated to a temperature of 140° C. for formation for 600 seconds and is then discharged out of the mold; a formed carbon fiber casing is pulled out of the fixture and is then subjected to deburring and surface treatment, so that the bottom reinforcing carbon fiber casing 1 is manufactured; then, the bottom reinforcing carbon fiber casing 1 is assembled on the PU foam 3;

S5, a certain quantity of PU foam 3 is injected into the wood or fiber stick 2 through a mold to form a desired shape, and redundant burrs are removed;

S6, a bottom, where the reinforcing carbon fiber casing 1 is to be assembled, of the PU foam 3 is roughened and coated with resin glue, and the reinforcing carbon fiber casing 1 is forcibly disposed around the bottom of the PU foam 3 after an inner wall of the reinforcing carbon fiber casing 1 is roughened and sand-blasted; and

S7, the reinforced PU foam 3 stands for about 7 days and is then laminated onto the wood or fiber stick by means of fiber woven fabric or a carbon sheet (synthesized by carbon fibers), so that the goalkeeper PU foam hockey stick is obtained.

According to the bottom carbon fiber casing of the goalkeeper PU foam hockey stick and the production process thereof, the reinforcing carbon fiber casing 1 is formed by heating fibers and epoxy resin in a mold, so that the strength of the whole goalkeeper PU foam hockey stick is improved; and compared with hockey sticks produced through traditional production processes, the goalkeeper PU foam hockey stick of the invention is resistant to impact and has the bottom being protected against cracks, and the service life of the goalkeeper PU foam hockey stick is effectively prolonged.

### Embodiment 3

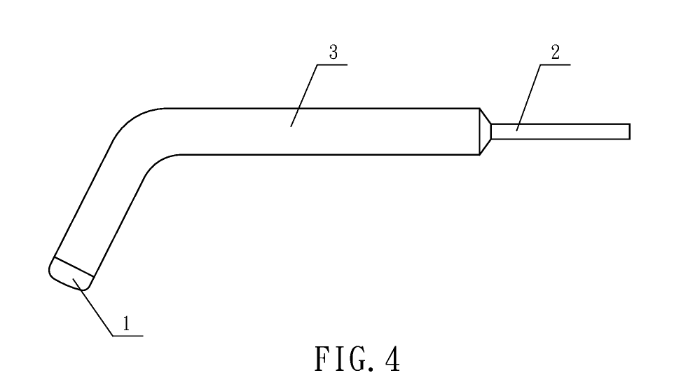

Referring to FIG. 4, according to the same production process as described in above, the reinforcing carbon fiber casing 1 can also provide on the toe portion of a goalkeeper PU form hockey stick or both on the bottom portion and the toe portion of the hockey stick to provide a better protection of the toe and the bottom.

The above embodiments are only preferred ones of the invention and are not intended to limit the protection scope of the invention. Any equivalent substitutes or variations made by those skilled in this technical field within the technical scope of this disclosure based on the technical solutions and concept of the invention should also fall within the protection scope of the invention.

What is claimed is:

1. A carbon fiber casing of a goalkeeper PU foam hockey stick, comprising a reinforcing carbon fiber casing (1), a wood or fiber stick (2) and PU foam (3), wherein a reinforcing part is arranged on the PU foam (3), the reinforcing carbon fiber casing (1) is forcibly disposed around the corresponding reinforcing part of the PU foam (3), and the PU foam (3) is laminated onto the wood or fiber stick (2) together with the reinforcing carbon fiber casing (1).

2. The carbon fiber casing of the goalkeeper PU foam hockey stick according to claim 1, wherein a surface of the reinforcing part of the PU foam (3) is coated with resin glue.

3. The carbon fiber casing of the goalkeeper PU foam hockey stick according to claim 1, wherein the PU foam (3), together with the reinforcing carbon fiber casing (1), is laminated onto the wood or fiber stick (2) by means of a special carbon sheet or woven fabric through a special machine.

4. The carbon fiber casing of the goalkeeper PU foam hockey stick according to claim 1, wherein the reinforcing carbon fiber casing is provided on the bottom of a hockey stick.

5. The carbon fiber casing of the goalkeeper PU foam hockey stick according to claim 1, wherein the reinforcing carbon fiber casing is provided on the toe of a hockey stick.

6. A production process of the carbon fiber casing of the goalkeeper PU foam hockey stick according to claim 1, comprising the following steps:
S1, manufacturing a metal fixture and a mold according to a shape of the bottom reinforcing part, wherein the metal fixture and the mold are completely matched with the reinforcing part in shape and size;
S2, laminating epoxy resin and fibers to form a piece of fabric having an FAW of 150#, and then cutting the fabric to a size required in a structure sheet;
S3, attaching a fiber resin material (the fabric) to the fixture after cutting, and vacuumizing the fiber resin material by a vacuum machine;
S4, placing the fixture attached with the fiber resin material in the heated mold for formation, and conducting deburring and surface treatment on a carbon fiber casing discharged out of the mold, so that the bottom reinforcing carbon fiber casing is formed;
S5, injecting a certain quantity of PU (3) foam into the wood or fiber stick (2) through a mold to form a desired shape, and removing redundant burrs;
S6, roughening a bottom, where the reinforcing carbon fiber casing is to be assembled, of the PU foam (3), coating the bottom of the PU foam with resin glue, and forcibly disposing the reinforcing carbon fiber casing (1) manufactured in S4 around the bottom of the PU foam (3), so that reinforcing is completed; and
S7, laminating the reinforced PU foam onto the wood or fiber stick by means of fiber woven fabric or a carbon sheet after the reinforced PU foam stands for about 7 days, so that the goalkeeper PU foam hockey stick is obtained.

7. The production process of the carbon fiber casing of the goalkeeper PU foam hockey stick according to claim 6, wherein in S4, the mold is heated to a temperature of 140° C., and a formation time is 600 s.

8. The production process of the carbon fiber casing of the goalkeeper PU foam hockey stick according to claim 1, wherein an inner wall of the reinforcing carbon fiber casing (1) is roughened and sand-blasted.
